(19) United States
(12) Patent Application Publication
(10) Pub. No.: US 2018/0136708 A1
(43) Pub. Date: May 17, 2018

(54) Dynamic Energy Storage Device Charging

(71) Applicant: Microsoft Technology Licensing, LLC, Redmond, WA (US)

(72) Inventors: Aniruddha Jayant Jahagirdar, Bellevue, WA (US); Ranveer Chandra, Kirkland, WA (US); Anirudh Badam, Issaquah, WA (US); James Anthony Schwartz, JR., Seattle, WA (US); Paresh Maisuria, Issaquah, WA (US); Matthew Holle, Kirkland, WA (US); M. Nashaat Soliman, Redmond, WA (US); Tapan Ansel, Redmond, WA (US)

(73) Assignee: Microsoft Technology Licensing, LLC, Redmond, WA (US)

(21) Appl. No.: 15/353,581

(22) Filed: Nov. 16, 2016

(51) Int. Cl. G06F 1/32; G06F 1/20; H02J 7/00

(52) U.S. Cl. CPC G06F 1/3206; H02J 7/0026; H02J 7/007; G06F 1/206

(57) ABSTRACT

A computing device has an energy storage device system with multiple energy storage devices. Various different criteria are used to determine which one or more of the multiple energy storage devices to charge at any given time to provide power to the computing device. The criteria can include characteristics of the energy storage devices and/or the computing device that change while the computing device operates, and estimated or predicted usage of the computing device. These criteria are evaluated during operation of the computing device, and the appropriate energy storage device(s) to charge at any given time based on these criteria are determined.

### BACKGROUND

As technology has advanced, mobile computing devices have become increasingly commonplace. Mobile computing devices provide various functionality to users, allowing the user to interact with the device to check email, surf the web, compose text messages, interact with applications, and so on. One challenge that faces developers of mobile computing devices is efficient power management and extension of battery life. If power management implemented for a device fails to provide a good battery life, user dissatisfaction with the device and manufacturer may result.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, in a computing device having an energy storage device system including multiple energy storage devices, a temperature for each of multiple thermal zones of the computing device is determined. Based on multiple criteria regarding operation of the computing device, one or more of the multiple energy storage devices to charge is determined, the multiple criteria including the temperature of each of the one or more thermal zones. The energy storage device system is configured to charge each of the one or more of the multiple energy storage devices.

In accordance with one or more aspects, in a computing device having an energy storage device system including multiple energy storage devices, values for multiple criteria regarding the computing device and/or multiple energy storage devices are determined. The multiple criteria include removable energy storage device presence predictions. Based on the values for the multiple criteria, a determination is made to charge a first energy storage device of the multiple energy storage devices, the values for the multiple criteria including an indication that a second energy storage device of the multiple energy storage devices is predicted to be removed from the computing device within a threshold amount of time. The energy storage device system is configured to charge the first energy storage device.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion

FIG. 1 illustrates an operating environment in accordance with one or more embodiments.

FIG. 2 depicts example details of a computing device having an energy storage device system with multiple energy storage devices in accordance with one or more implementations.

FIG. 3 depicts one illustrative example charging architecture for an energy storage device system having multiple energy storage devices.

FIG. 4 is a flow diagram that describes details of an example procedure for dynamic energy storage device charging in accordance with one or more implementations.

FIG. 5 illustrates an example system that includes an example computing device that is representative of one or more computing systems and/or devices that may implement the various techniques described herein.

### DETAILED DESCRIPTION

Overview

Dynamic energy storage device charging is described for a computing device having an energy storage device system with multiple energy storage devices. These multiple energy storage devices can be the same types of energy storage devices or alternatively different types of energy storage devices having various different characteristics such as different sizes, capacities, technologies, chemistries, shapes, age, cycles, temperature, and so forth. Various different criteria are used to determine which one or more of the multiple energy storage devices to charge at any given time.

The criteria used to determine which one or more of the multiple energy storage devices to charge at any given time include static criteria, dynamic system criteria, and prediction criteria. The static criteria refers to characteristics of the energy storage devices as well as hardware and/or physical characteristics of the computing device that do not change while the computing device operates (e.g., while executing different programs). The dynamic system criteria refers to characteristics of the energy storage devices and/or the computing device that changes while the computing device operates (e.g., while executing different programs). The prediction criteria refers to estimated or predicted user behavior (e.g., predicting the intent of the user), program behavior (e.g., predicting how the software installed is using/causing usage of the system, such as an antivirus service), and/or more general usage of the computing device, such as removal of hot-swappable batteries, duration of connection to an AC power source, workload and/or power usage of the computing device, and so forth.

These criteria are evaluated during operation of the computing device, and the appropriate energy storage device(s) to charge at any given time based on these criteria are determined. The techniques discussed herein allow the multiple energy storage devices to be charged in a manner that accommodates the particular computing device as well as the user's typical use of the computing device. Smarter decisions can be made regarding which energy storage device to charge, which can allow the computing device to be run on energy storage device power for a longer duration of time and can extend the lifespan of the energy storage devices.

In the discussion that follows, a section titled “Operating Environment” is provided and describes one example environment in which one or more implementations can be employed. Following this, a section titled “Energy Storage Device Charge Selection System Details” describes example details and procedures in accordance with one or more implementations. Last, a section titled “Example System” describes example computing systems, components, and devices that can be utilized for one or more implementations of dynamic energy storage device charging.

Operating Environment

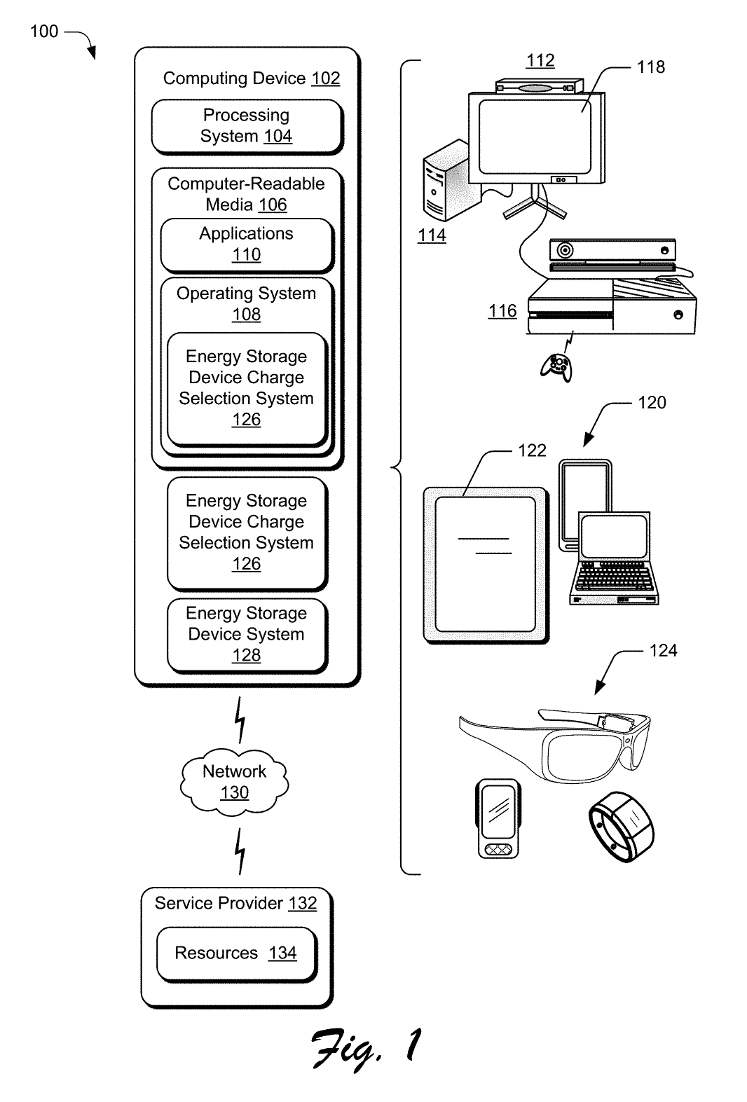

FIG. 1 illustrates an operating environment in accordance with one or more embodiments, generally at 100. The environment 100 includes a computing device 102 having a processing system 104 with one or more processors and devices (e.g., CPUs, GPUs, microcontrollers, hardware elements, fixed logic devices, etc.), one or more computer-readable media 106, an operating system 108, and optionally one or more applications 110 that reside on the computer-readable media and which are executable by the processing system. The processing system 104 may be configured to include multiple independent processors configured in parallel or in series and one or more multi-core processing units. A multi-core processing unit may have two or more processors (“cores”) included on the same chip or integrated circuit. In one or more implementations, the processing system 104 may include multiple processing cores that provide a range of performance capabilities, processing efficiencies, and power usage characteristics.

The processing system 104 may retrieve and execute computer-program instructions from applications 110 to provide a wide range of functionality to the computing device 102, including but not limited to gaming, office productivity, email, media management, printing, networking, web-browsing, and so forth. A variety of data and program files related to the applications 110 can also be included, examples of which include games files, office documents, multimedia files, emails, data files, web pages, user profile and/or preference data, and so forth.

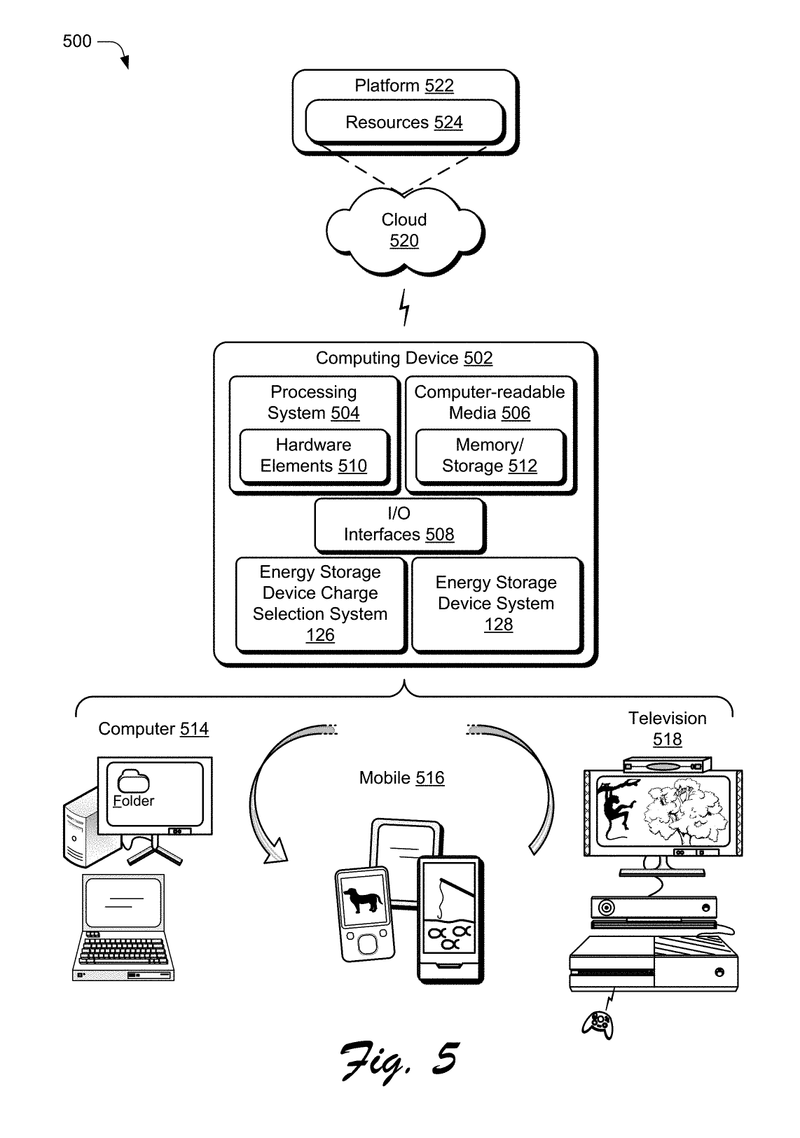

The computing device 102 can be embodied as any suitable computing system and/or device such as, by way of example and not limitation, a gaming system, a desktop computer, a rack server or other server computer, a portable computer, a tablet or slate computer, a handheld computer such as a personal digital assistant (PDA), a cell phone, a set-top box, a wearable device (e.g., watch, band, glasses, virtual reality (VR) headsets, augmented reality (AR) headsets, etc.), a home computing device (e.g., a voice-controlled wireless speaker or other smart-home device), an enterprise commodity device (e.g., an automated teller machine (ATM)), other consumer devices (e.g., drones, smart clothing, etc.), and so forth. For example, as shown in FIG. 1 the computing device 102 can be implemented as a television client device 112, a computer 114, and/or a gaming system 116 that is connected to a display device 118 to display media content. Alternatively, the computing device may be any type of portable computer, mobile phone, or portable device 120 that includes an integrated display 122. A computing device may also be configured as a wearable device 124 that is designed to be worn by, attached to, carried by, or otherwise transported by a user. Examples of wearable devices 124 depicted in FIG. 1 include glasses, headsets, a smart band or watch, and a pod device such as clip-on fitness device, media player, or tracker. Other examples of wearable devices 124 include but are not limited to badges, a key fob, an access card, and a ring, an article of clothing, a glove, or a bracelet, to name a few examples. Any of the computing devices can be implemented with various components, such as one or more processors and memory devices, as well as with any combination of differing components. One example of a computing system that can represent various systems and/or devices including the computing device 102 is shown and described below in relation to FIG. 5.

The computer-readable media can include, by way of example and not limitation, all forms of volatile and non-volatile memory and/or storage media that are typically associated with a computing device. Such media can include ROM, RAM, flash memory, hard disk, removable media and the like. Computer-readable media can include both “computer-readable storage media” and “communication media,” examples of which can be found in the discussion of the example computing system of FIG. 5.

The computing device 102 also includes an energy storage device charge selection system 126 and an energy storage device system 128 that operate as described above and below. The energy storage device system 128 is configured to include multiple energy storage devices as discussed in greater detail below. The storage device charge selection system 126 can be implemented as part of the operating system 108, can be implemented as separate from the operating system 108, or can be implemented in part by the operating system 108 and in part separate from the operating system 108. The energy storage device charge selection system 126 can optionally be implemented as one or more discreet systems 126 working in concert. The energy storage device charge selection system 126 and energy storage device system 128 may be provided using any suitable combination of hardware, software, firmware, and/or logic devices. As illustrated, the energy storage device charge selection system 126 and energy storage device system 128 may be configured as separate, standalone systems. In addition or alternatively, the energy storage device charge selection system 126 may also be configured as a system or module that is combined with the operating system 108 or implemented via a controller or other component of the energy storage device system 128.

The energy storage device charge selection system 126 represents functionality operable to manage energy storage devices of the energy storage device system 128, allowing selection of different energy storage devices for charging at different times. This may involve analyzing various criteria including static criteria for the computing device 102, dynamic system criteria for the computing device 102, and/or prediction criteria for the computing device 102. The static criteria, in contrast to the dynamic system criteria for the computing device 102, do not typically change while the computing device 102 operates. The static criteria for the computing device 102 refers to characteristics of the energy storage devices that are part of the energy storage device system 128, hardware included in and/or other physical characteristics of (such as the locations of hardware in) the computing device 102, characteristics of static software and/or firmware, static properties such as interconnect resistance or thermal zone layout (e.g., which devices are in which thermal zones) as discussed in more detail below, and so forth. The dynamic system criteria for the computing device 102 refers to characteristics of the energy storage devices that are part of the energy storage device system 128 and/or the computing device 102 that changes while the computing device 102 operates (e.g., runs the operating system 108 and one or more applications 110). The prediction criteria for the computing device 102 refers to estimated or predicted user behavior, program behavior, and/or more general usage of the computing device 102, such as removal or insertion of hot-swappable batteries that are part of the energy storage device system 128, duration of a connection of the computing device 102 to an AC power source, expected future workload and/or power usage of the computing device 102, and so forth.

The energy storage device charge selection system 126 can manage the energy storage devices by controlling modes of the energy storage device system 128, states of battery cells or other energy storage devices of the energy storage device system 128, availability of energy storage devices of the energy storage device system 128, and so forth. For example, the energy storage device charge selection system 126 is operable to communicate control signals or otherwise interact with the energy storage device system 128 to direct operation of switching hardware to switch between energy storage devices to provide charging current to energy storage devices of the energy storage device system 128 in accordance with the analysis performed by the energy storage device charge selection system 126. Details regarding these and other aspects of dynamic energy storage device charging are discussed in the following section.

The environment 100 further depicts that the computing device 102 may be communicatively coupled via a network 130 to a service provider 132, which enables the computing device 102 to access and interact with various resources 134 made available by the service provider 132. The resources 134 can include any suitable combination of content and/or services typically made available over a network by one or more service providers. For instance, content can include various combinations of text, video, ads, audio, multi-media streams, applications, animations, images, webpages, and the like. Some examples of services include, but are not limited to, an online computing service (e.g., “cloud” computing), an authentication service, web-based applications, a file storage and collaboration service, a search service, messaging services such as email and/or instant messaging, and a social networking service.

Having described an example operating environment, consider now example details and techniques associated with one or more implementations of dynamic energy storage device charging.

Energy Storage Device Charge Selection System Details

To further illustrate, consider the discussion in this section of example devices, components, procedures, and implementation details that may be utilized to provide dynamic energy storage device charging as described herein. In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

Example Device

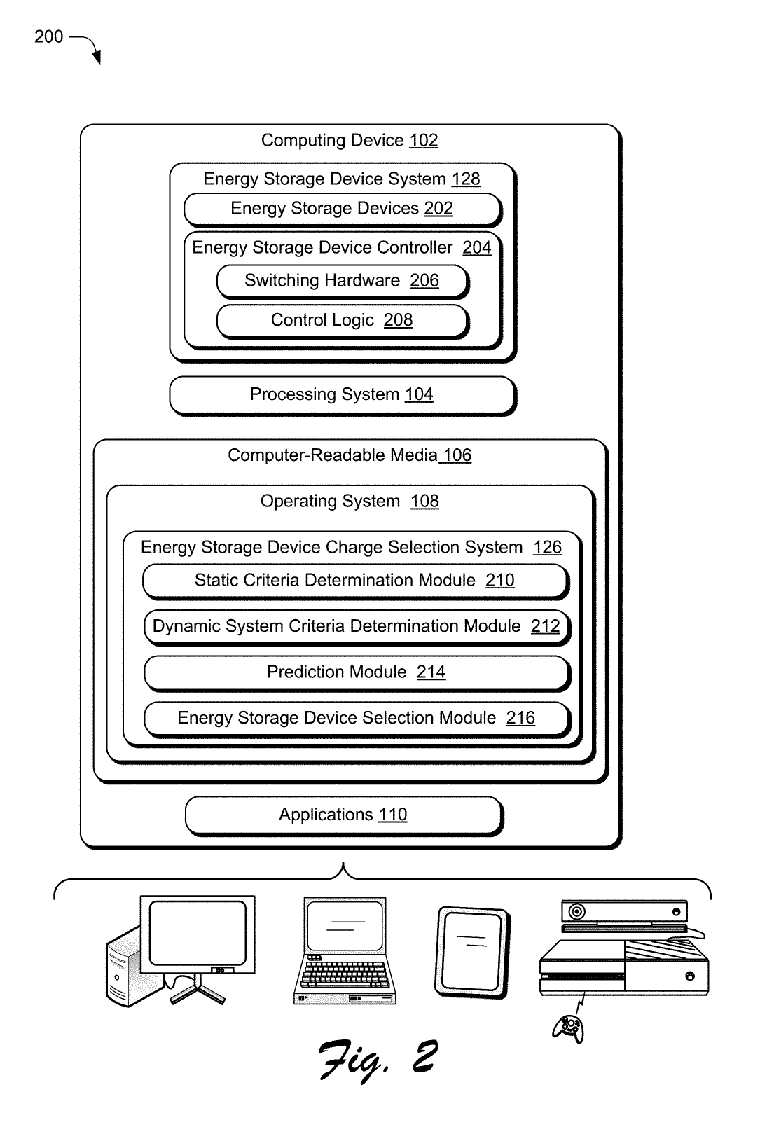

FIG. 2 depicts generally at 200 example details of a computing device 102 having an energy storage device system 128 with multiple energy storage devices in accordance with one or more implementations. Computing device 102 also includes processing system 104, computer readable media 106, operating system 108 and applications 110 as discussed in relation to FIG. 1. In the depicted example, an energy storage device charge selection system 126 is also shown as being implemented as a component of the operating system 108. It should be noted, however, that the energy storage device charge selection system 126 can alternatively be implemented in other manners. For example, parts of (or all of) the energy storage device charge selection system 126 can be implemented as part of the energy storage device system 128.

By way of example and not limitation, the energy storage device system 128 is depicted as having energy storage devices 202 and an energy storage device controller 204. The energy storage devices 202 are representative of various different kinds of energy storage devices that may be included and/or compatible with the computing device 102. These energy storage devices can include, for example, individual or a collection of battery cells, supercapacitors, and so forth. Energy storage devices 202 can include energy storage devices that are designed to be included in and specifically work with the computing device 102 at the time of manufacture or distribution, and/or external energy storage devices (e.g., original equipment manufacturer (OEM) manufactured external batteries) that are added to the computing device 102 (e.g., by the user) at a later point in time. Energy storage devices 202 can include energy storage devices having different characteristics such as different sizes, capacities, chemistries, battery technologies, shapes, age, cycles, temperature, and so forth (heterogeneous energy storage devices). Accordingly, the energy storage device system 128 can include a diverse combination of multiple energy storage devices at least some of which can have different characteristics one to another. Alternatively, the energy storage devices 202 can include energy storage devices having the same characteristics. Various combinations of energy storage devices 202 may be utilized to provide a range of capacities, performance capabilities, efficiencies, power usage characteristics, and utilization of space in the device (e.g., for the purpose of balancing the weight, increasing energy storage capacity and/or energy storage characteristics), and so forth.

The energy storage device controller 204 is representative of a control system to control operation of the energy storage device system 128, to control delivery of power from the energy storage devices 202 to service a system load of the computing device 102, and to control delivery of power to the energy storage devices 202 to charge the energy storage devices 202. The system load refers to the energy required by the computing device 102 at any given point in time in order to operate. The energy storage device controller 204 may be configured using various logic, hardware, circuitry, firmware, and/or software suitable to connect the energy storage devices 202 one to another, supply power to the system, switch between the energy storage devices, and so forth. By way of example and not limitation, the energy storage device controller 204 in FIG. 2 is depicted as including switching hardware 206 and control logic 208 that is operable to selectively switch between use of different designated sources of the energy storage devices 202 at different times. Control logic 208 may reflect different switching modes that switch between charging different ones of the energy storage devices 202 so that power is provided to ones of the energy storage devices 202 based on various criteria as determined by the energy storage device charge selection system 126. Thus, rather than merely interconnecting energy storage devices in parallel or series, switching hardware 206 can be utilized to set-up a switching scheme to select different energy storage devices based on different criteria for the computing device 102.

The energy storage device charge selection system 126 includes a static criteria determination module 210, a dynamic system criteria determination module 212, a prediction module 214, and an energy storage device selection module 216.

The static criteria determination module 210 represents functionality operable to determine values for various characteristics of the energy storage devices 202, as well as hardware components included in and/or other physical characteristics of (such as the locations of hardware included in) the computing device 102, characteristics of static software and/or firmware, static properties such as interconnect resistance or thermal zone layout (e.g., which devices are in which thermal zones) as discussed in more detail below, and so forth. These hardware components can include, for example, components of the processing system 104.

In one or more embodiments, the static criteria includes an energy storage device charge level. For many energy storage devices, the efficiency of the energy storage device charging degrades as the energy storage device is charged. Thus, an energy storage device when 25% charged can be charged more efficiently than when the energy storage device has an 85% charge. A threshold charge level is set, and whether the energy storage device has satisfied the threshold charge level (e.g., has a charge level at and/or greater than the threshold charge level) is determined. A value for the energy storage device charge level criteria is generated based on whether the energy storage device has satisfied the threshold charge level. For example, a value of 1 or True can be used to indicate that the energy storage device has satisfied the threshold charge level, and a value of 0 or False can be used to indicate that the energy storage device has not satisfied the threshold charge level.

The threshold charge level can be set in a variety of different manners, such as based on an energy storage device charge curve. The energy storage device charge curve is a plot of amount of charge (remaining charge) versus time for the energy storage device as the energy storage device charges. The charge curve drops slower (has a less negative slope) at later times in the plot than at earlier times. That is, the charge curve drops slower the higher the remaining charge is in the energy storage device. Different energy storage devices can have different charge curves. The threshold charge level can be set based on the charge curve, such as when the charge curve starts to drop at a particular rate (e.g., starts to drop at a rate that is 10% slower than the highest rate, has a slope of −0.1, etc.). The charge curve can be obtained in a variety of different manners, such as from the supplier or manufacturer of the energy storage device, based on observations of charging the energy storage device by the computing device 102 (e.g., by the operating system 108 and/or energy storage device charge selection system 126), and so forth.

The energy storage device selection module 216 can use the threshold charge level in various different manners. In one or more embodiments, the energy storage device selection module 216 selects for a component an energy storage device to power that component that satisfies the threshold charge level for that energy storage device.

In one or more embodiments, the static criteria includes an identification of charge paths in the computing device 102. A charge path is a route for current between a power source and an energy storage device 202 being charged by that power source. The identification of the charge path can include, for example, an indication of which components are included in the charge path, which thermal zones of the computing device the charging path passes through, and so forth.

The energy storage device selection module 216 can use the identification of the charge paths in various different manners. For example, in conjunction with the identification of thermally hot zones as discussed in more detail below, the energy storage device selection module 216 can select to charge energy storage devices 202 having charge paths that do not pass through a thermally hot zone.

The dynamic system criteria determination module 212 represents functionality operable to determine values for various characteristics of the energy storage devices 202 and/or of the computing device 102 that changes while the computing device 102 operates (e.g., while the computing device 102 runs the operating system 108 and one or more applications 110). The criteria used by the dynamic system criteria determination module 212 are referred to as dynamic because they change over time during operation of the computing device 102. For example, the criteria used by the dynamic system criteria determination module 212 can include the temperature of a thermal zone of the computing device 102, which changes over time during operation of the computing device 102, the ages of the energy storage devices 202, and so forth.

In one or more embodiments, the dynamic system criteria involve different thermal zones in the computing device 102. A thermal zone refers to a group of one or more components (e.g., hardware) in the computing device 102 that are treated collectively for purposes of temperature control. Different thermal zones can optionally have different cooling mechanisms, such as vents, fans, heat sinks, and so forth. The energy storage device charge selection system 126 can obtain an indication of which components of the computing device 102 are in which thermal zones in various manners, such as from the supplier or manufacturer of the computing device 102. In one or more embodiments in which the computing device 102 supports the Advanced Configuration and Power Interface (ACPI) Specification, such as the Advanced Configuration and Power Interface Specification, Version 6.1 (January, 2016), the energy storage device charge selection system 126 can obtain an indication of the thermal zones in the computing device 102, and optionally which components of the computing device 102 are in which thermal zones, by invoking methods of the ACPI.

In one or more embodiments, the dynamic system criteria includes an indication of whether each of the energy storage devices 202 is in a thermally hot (also referred to as thermally active) zone. The dynamic system criteria determination module 212 can obtain indications of temperatures of the different thermal zones in the computing device 102 in various manners, such as via the ACPI, by accessing temperature gauge components in the computing device 102, and so forth. A thermal zone is referred to as a hot zone or a thermally hot zone if the temperature of the thermal zone satisfies (e.g., is the same as, is the same as or equal to) a threshold temperature. In one or more embodiments, the threshold temperature is a value above which the designer or supplier of the computing device 102 prefers that the thermal zone not run. The threshold temperature can be, for example, a particular temperature (e.g., 85 degrees Fahrenheit), or a relative value (e.g., 80% of a maximum operating temperature of the computing device 102 as specified by the designer or supplier of the computing device 102).

The dynamic system criteria determination module 212 can also obtain an indication of which components, including which energy storage devices 202, are in which thermal zones. A value for each energy storage device can be generated based on whether the energy storage device is in a thermally hot zone. For example, a value of 1 or True can be used to indicate that the energy storage device is in a thermally hot zone, and a value of 0 or False can be used to indicate that the energy storage device is not in a thermally hot zone (which may also be referred to as a thermally stable zone).

The energy storage device selection module 216 can use the values indicating which energy storage devices are in a thermally hot zone and which energy storage devices are not in a thermally hot zone in various different manners. In one or more embodiments, the energy storage device selection module 216 selects an energy storage device that is not in a thermally hot zone for charging. The temperature of an energy storage device typically increases as current is provided to the energy storage device, and by selecting an energy storage device that is not in a thermally hot zone the energy storage device charge selection system 126 facilitates managing thermal stability of the computing device 102 (e.g., keeping a thermal zone of the computing device 102 from getting too hot) when selecting which energy storage devices 202 to charge.

In one or more embodiments, the dynamic system criteria includes an indication of which thermal zones the energy storage devices 202 are in. A value for each energy storage device that is the thermal zone the energy storage device 202 is in (e.g., 1, 2, 3, etc.) is determined. Alternatively, a value for each energy storage device can be generated based on, for example, how recently or some duration that current has been provided to the energy storage device for charging. This value can take various forms, such as a number of milliseconds, one value (e.g., 1 or True) to indicate that current has recently been provided to the energy storage device for charging and another value (e.g., 0 or False) to indicate that current has not recently been provided to the energy storage device for charging, and so forth.

The energy storage device selection module 216 can use the values indicating which thermal zones the energy storage devices are in in various different manners. In one or more embodiments, the energy storage device selection module 216 selects an energy storage device to duty cycle providing current to the energy storage devices in different thermal zones. The temperature of an energy storage device typically increases as current is provided to the energy storage device for charging, so by duty cycling the energy storage devices in different thermal zones the increase in heat as a result of charging the energy storage devices is effectively reduced. For example, if there are three energy storage devices, the energy storage device selection module 216 selects a first of the three energy storage devices for charging for a particular amount of time (e.g., 5 seconds), then selects a second of the three energy storage devices for charging for a particular amount of time (e.g., 5 seconds), then selects a third of the three energy storage devices for charging for a particular amount of time (e.g., 5 seconds), then selects the first of the three energy storage devices for charging for a particular amount of time (e.g., 5 seconds), and so forth.

In one or more embodiments, the energy storage device charge selection system 126 selects an energy storage device that is not in a thermally hot zone for charging. However, situations can arise in which all of the energy storage devices are in thermally hot zones (whether the same or different thermal hot zones). In such situations, the energy storage device charge selection system 126 can select no energy storage devices for charging. Alternatively, the energy storage device charge selection system 126 can select at least a subset (e.g., all) of the energy storage devices for charging, and charge those selected energy storage devices with a reduced current in order to reduce the increase in temperature of the energy storage devices when charging. The current can be reduced in various manners such as providing a smaller amount of current to the energy storage devices than is available to the energy storage device system 128. The energy storage device charge selection system 126 can also select energy storage devices to duty cycle providing current to the energy storage devices, spreading the increase in heat as a result of charging the energy storage devices across the different energy storage devices in the subset.

In one or more embodiments, the dynamic system criteria includes an indication of whether the charge path to each of the energy storage devices 202 passes through a thermally hot (also referred to as thermally active) zone. The charge path refers to the various components that energy passes through when being provided to a particular energy storage device to charge the energy storage device. The dynamic system criteria determination module 212 can obtain indications of temperatures of the different thermal zones in the computing device 102 in various manners, as discussed above. The dynamic system criteria determination module 212 can also obtain an indication of which components, including the various components included in the various charge paths, are in which thermal zones. A value for each energy storage device can be generated based on whether the charge path passes through a thermally hot zone. For example, a value of 1 or True can be used to indicate that the charge path passes through a thermally hot zone, and a value of 0 or False can be used to indicate that the charge path does not pass through a thermally hot zone (which may also be referred to as a thermally stable zone).

The energy storage device selection module 216 can use the values indicating which charge paths pass through a thermally hot zone and which charge paths do not pass through a thermally hot zone in various different manners. In one or more embodiments, the energy storage device selection module 216 selects to charge an energy storage device that receives power via a charge path that does not pass through a thermally hot zone. By selecting to charge an energy storage device that receives power via a charge path that does not pass through a thermally hot zone, the energy storage device charge selection system 126 facilitates managing thermal stability of the computing device 102 (e.g., keeping a thermal zone of the computing device 102 from getting too hot) when selecting which energy storage devices 202 to charge.

In one or more embodiments, the dynamic system criteria (or the static system criteria) includes an indication of which thermal zones the charge paths for each of the energy storage devices 202 pass through. A value for each energy storage device that is the thermal zone(s) the charge path to the energy storage device 202 passes through (e.g., 1, 2, 3, etc.) is determined. Alternatively, a value for each energy storage device can be generated based on, for example, how recently or some duration that the energy storage device has been charged. This value can take various forms, such as a number of milliseconds, one value (e.g., 1 or True) to indicate that the energy storage device has been recently charged and another value (e.g., 0 or False) to indicate that the energy storage device has not been recently charged, and so forth.

The energy storage device selection module 216 can use the values indicating which thermal zones the charge paths pass through in various different manners. In one or more embodiments, the energy storage device selection module 216 selects an energy storage device to duty cycle power through different charge paths that pass through different thermal zones. By duty cycling the charge paths, the energy storage device charge selection system 126 facilitates managing thermal stability of the computing device 102 (e.g., keeping a thermal zone of the computing device 102 from getting too hot) when selecting which energy storage devices 202 to charge.

The prediction module 214 represents functionality operable to determine values for various characteristics of estimated or predicted user behavior (e.g., predicting the intent of the user), program behavior (e.g., predicting how the software installed is using/causing usage of the system, such as an antivirus service), and/or more general usage of the computing device 102. This predicted behavior or usage can include, for example, removal or insertion of hot-swappable batteries that are part of the energy storage device system 128, duration of a connection of the computing device 102 to an AC power source, expected future workload and/or power usage of the computing device 102, and so forth.

In one or more embodiments, the predicted behavior or usage includes removable energy storage device presence predictions. A removable energy storage device refers to an energy storage device that can be disengaged from the energy storage device system 128, such as removed from the housing that includes other components of the computing device 102 (such as the processing system 104). The removable energy storage device can be implemented in various manners, such as a hot-swappable energy storage device (which refers to an energy storage device that can be inserted into and withdrawn from the housing during operation of the computing device 102 while the computing device 102 is not powered off), a cold-swappable battery energy storage device (which refers to an energy storage device that can be inserted into and withdrawn only when the computing device is not functional (e.g., is powered off)), an energy storage device in a removable peripheral device (e.g., an energy storage device in a keyboard coupled to the housing, which can be hot-swappable or cold-swappable), an energy storage device in a case or protective cover of the computing device 102 (which can be hot-swappable or cold-swappable), and so forth.

A value is obtained for each removable energy storage device indicating whether the energy storage device is predicted to be no longer present (e.g., removed) in the near future. For example, a value of 1 or True can be used to indicate that the removable energy storage device is predicted to be removed in the near future, and a value of 0 or False can be used to indicate that the removable energy storage device is not predicted to be removed in the near future. Values can be obtained for all removable energy storage devices, or alternatively only for certain energy storage devices (e.g., hot-swappable energy storage devices). By way of another example, a non-binary value may be used to indicate whether the energy storage device is predicted to be no longer present (e.g., removed) in the near future, such as a probability value (e.g., a percentage ranging from 0% to 100%) of how likely it is that the energy storage device will be removed in the near future.

The energy storage device selection module 216 can use the values representing whether the removable energy storage devices are predicted to be no longer present (e.g., removed) in the near future in various different manners. In one or more embodiments, if a removable energy storage device (e.g., a hot-swappable energy storage device) is predicted to be removed in the near future, then the removable energy storage device selection module 216 selects to charge an energy storage device that is not predicted to be removed in the near future. By charging an energy storage device that is not predicted to be removed in the near future power is not expended charging an energy storage device that is expected to removed (and thus not usable as a power source for the computing device 102) soon anyway.

In one or more embodiments, an energy storage device predicted to be removed in the near future refers to an energy storage device that is predicted to be removed within some threshold value. This threshold value can be, for example, a threshold amount of time of the current time (such as on the order of minutes or hours, such as 10 minutes or 2 hours). This threshold value can also be a threshold amount of energy, such as an absolute energy value or a percent value.

The prediction module 214 can estimate or predict that a removable energy storage device is to be removed in the near future in a variety of different manners. In one or more embodiments, the prediction module 214 maintains a record (e.g., over a matter of weeks or months) indicating times of the day and/or days of the week that the removable energy storage device is present and times of the day and/or days of the week that the removable energy storage device is not present. From this record, the prediction module 214 can identify usage patterns that indicate when the removable energy storage device is not present at the computing device 102 and the durations when the removable energy storage device is not present at the computing device 102. Any of a variety of public and/or proprietary techniques can be used to analyze the record to identify these usage patterns.

For example, if every Monday (or at least a threshold number of Mondays, such as 80%) from 3:00 pm-5:00 pm the removable energy storage device is not present at the computing device 102, then the prediction module 214 can predict that on the following Monday from 3:00 pm-5:00 pm the removable energy storage device will not be present at the computing device 102. By way of another example, if every day of the week (or at least a threshold number of days, such as 75%) from noon-1:00 pm the removable energy storage device is not present at the computing device 102, then the prediction module 214 can predict that, if it is currently 11:00 am, the removable energy storage device will not be present at the computing device 102 from noon-1:00 pm on the current day.

Additionally or alternatively, the prediction module 214 can estimate or predict that a removable energy storage device is to be removed in the near future based on any of a variety of other data. The prediction module 214 can obtain data from various different sources and analyze the data using any of a variety of public and/or proprietary techniques to identify expected future usage patterns.

By way of example, the prediction module 214 can obtain data from a calendar of the user of the computing device 102. The calendar can include appointments or meetings with locations away from the user's office or home, and the prediction module 214 can predict, for example, that a removable energy storage device will not be present at the computing device 102 during those appointments or meetings.

By way of example, the prediction module 214 can obtain data from a cloud service that collects usage data for computing devices. The cloud service can provide an indication of times of the day and/or days of the week when users of computing devices of the same type as computing device 102 have a removable energy storage device not present. The prediction module 214 can predict, for example, that a removable energy storage device will not be present at the computing device 102 during those times of the day and/or days of the week indicated by the cloud service.

Similarly, the estimated or predicted usage of the computing device can include energy storage device use predictions. In addition to not using an energy storage device to power the computing device 102 because the energy storage device has been removed, a determination can be made that an energy storage device will not be used for powering the computing device 102 for various other reasons. Examples of such reasons include age balancing of the energy storage devices, inability to charge the energy storage device up to its optimal charge curve path, and so forth. In one or more embodiments, if an energy storage device is predicted to not be used for powering the computing device 102, then the removable energy storage device selection module 216 selects to charge an energy storage device that is predicted to be used for powering the computing device 102. By charging an energy storage device that is predicted to be used for powering the computing device 102 power is not expended charging an energy storage device that is expected not to be used for powering the computing device 102 anyway.

The prediction module 214 can estimate or predict various timing information regarding when the computing device is to be connected to an AC power source, such as how soon the computing device will be connected to an AC power source and/or for how long (a duration that) the computing device will be connected to the AC power source. Although references are made herein to an AC power source, it should be noted that such references can refer to any external power source such as an AC power source, a wireless power source, and/or an external energy storage device. In one or more embodiments, the predicted behavior or usage includes predicted duration of a connection of the computing device 102 to an AC power source (a charging window). A value is determined indicating a time duration that the computing device 102 is predicted to be connected to an AC power source. For example, a value that is a number of seconds or minutes can be determined to indicate the time duration that the computing device 102 is predicted to be connected to an AC power source. By way of another example, a value can be determined that is an amount of energy predicted to be drawn (e.g., available) from an AC power when the computing device 102 is predicted to be connected to the AC power source.

The energy storage device selection module 216 can use the value indicating the time duration that the computing device 102 is predicted to be connected to an AC power source in various different manners. In one or more embodiments, if the computing device is predicted to be connected to an AC power source for a small amount of time and/or to a weak AC power source (e.g., an AC power source that is not sufficient to charge energy storage devices 202 such that they may supply sufficient or desired energy to the computing device 102), then the energy storage device selection module 216 selects to charge an energy storage device capable of rapid charging (and rapid charges the selected energy storage device). This small amount of time is, for example, less than a threshold amount of time, which can be a fixed amount of time (e.g. 5 minutes) or a percentage (e.g., 25% of an estimated amount of time to fully charge the energy storage devices in the computing device in light of their current charge levels). This small amount of time can also be based on an amount of energy ingested, such as being an amount of time insufficient for the energy storage device to ingest (e.g., be charged with), at a lower (e.g., non-rapid) charge rate, enough energy to power the system for a desired amount of time. In embodiments in which the energy storage devices 202 include different types of energy storage devices, those different types of energy storage devices can support different charge rates. An energy storage device capable of rapid charging refers to an energy storage device that can be charged at rapid rate. This rapid rate can be a threshold rate (e.g., at least 1000 milliamps/hour), or a relative rate based on the other energy storage devices in the computing device (e.g., the rapid rate can be a rate faster than all or at least one other energy storage device in the computing device).

In one or more embodiments, when the computing device 102 is running hot (thermally active) but the prediction module 214 detects a small charging window coming up where a rapid-current can be consumed from the charging source, the computing device 102 will employ thermal conditioning techniques (such as turning on fans or other passive thermal conditioning techniques), in advance of the charging window to prepare one or more energy storage devices 202 to ingest (consume) full rapid-charging current. These conditioning techniques can reduce the temperature of the computing device, and reduce overheating of the computing device 102.

Additionally or alternatively, the decision to rapid charge an energy storage device may be made purely based on the amount of energy predicted to be used by the computing device 102, the amount of energy available in the energy storage device 202, and the amount of power predicted to be available for consumption from the AC power source, as described above.

In one or more embodiments, if the computing device is predicted to be connected to an AC power source for a small amount of time, then the energy storage device selection module 216 selects to charge an energy storage device capable of rapid charging regardless of whether that energy storage device is in a thermally hot zone. Alternatively, if the computing device is predicted to be connected to an AC power source for a small amount of time and if all of the energy storage devices capable of rapid charging are in thermally hot zones, then the energy storage device selection module 216 provides an indication to the operating system 108 to throttle (e.g., reduce) the software and/or hardware performance levels until a sufficient amount of energy is ingested by the energy storage devices 202 to power the predicted energy requirement of the system, and commence rapid charging (e.g., ingesting full charging current) of one or more energy storage devices 202.

The prediction module 214 can estimate or predict the time duration of the computing device being connected to an AC power source in a variety of different manners. In one or more embodiments, the prediction module 214 maintains a record (e.g., over a matter of weeks or months) indicating times of the day and/or days of the week that the computing device is connected to an AC power source. From this record, the prediction module 214 can identify usage patterns that indicate when the computing device is connected to an AC power source and the durations when the computing device is connected to an AC power source. Any of a variety of public and/or proprietary techniques can be used to analyze the record to identify these usage patterns.

For example, if every Sunday (or at least a threshold number of Sundays, such as 80%) from noon to midnight the computing device is connected to an AC power source, then the prediction module 214 can predict that on the following Sunday at noon the computing device will be connected to an AC power source for 12 hours. By way of another example, if every day of the week (or at least a threshold number of days, such as 75%) from midnight to 6:00 am the computing device is connected to an AC power source, then the prediction module 214 can predict that, at midnight, the computing device will be connected to an AC power source for 6 hours.

Additionally or alternatively, the prediction module 214 can estimate or predict the time duration that the computing device will be connected to an AC power source based on any of a variety of other data. The prediction module 214 can obtain data from various different sources and analyze the data using any of a variety of public and/or proprietary techniques to identify expected future usage patterns.

By way of example, the prediction module 214 can obtain data from a calendar of the user of the computing device 102. The past usage data (the record indicating times of the day and/or days of the week that the computing device connected to an AC power source) can be compared to the user's calendar and a determination made that during meetings (or meetings at particular locations) the computing device is connected to an AC power source. The prediction module 214 can predict, for example, that the computing device will be connected to an AC power source for the duration of upcoming meetings (or meetings at particular locations) identified in the user's calendar.

By way of another example, the prediction module 214 can obtain location data for the computing device 102, such as from a location awareness module of the computing device 102 (e.g., using a global positioning system (GPS), Bluetooth, Wi-Fi, triangulation, etc.). The past usage data (the record indicating times of the day and/or days of the week that the computing device connected to an AC power source) can be compared to the user's locations and a determination made that at certain locations (e.g., home) the computing device is connected to an AC power source. The prediction module 214 can predict, for example, that the computing device will be connected to an AC power source for more than a small amount of time if the user is at home, but that the computing device will be connected to an AC power source for a small amount of time if the user is not at home and heading towards work (based on calendar entries, meeting appointments, etc.).

By way of example, the prediction module 214 can obtain data from a cloud service that collects usage data for computing devices. The cloud service can provide an indication of, for various times of the day and/or days of the week, the duration that users of computing devices of the same type as computing device 102 have their computing devices connected to an AC power source. The prediction module 214 can predict, for example, that the computing device 102 will be connected to an AC power source for those durations at those times of the day and/or days of the week indicated by the cloud service.

In one or more embodiments, the predicted behavior or usage includes expected future workload and/or power usage of the computing device 102. The expected future workload and/or power usage of the computing device 102 is determined, and a determination is made as to whether there is sufficient charge in the energy storage devices to perform the expected future workload and/or power usage of the computing device 102. A value is determined indicating whether there is sufficient charge in the energy storage devices to perform the expected future workload and/or power usage of the computing device 102. The expected future workload and/or power usage of the computing device 102 can be used, for example. as a factor in determining whether the charge in the energy storage devices is sufficient for some amount of time.

The energy storage device selection module 216 can use the values representing whether there is sufficient charge in the energy storage devices to perform the expected future workload and/or power usage of the computing device 102 in various different manners. In one or more embodiments, if there is sufficient charge in the energy storage devices to perform the expected future workload and/or power usage of the computing device 102, then the energy storage device selection module 216 selects to charge the energy storage devices in a balanced manner. This balanced manner can include, for example, duty cycling providing power to the energy storage devices.

The energy storage device selection module 216 optionally determines to provide power to the energy storage devices in a balanced manner in response to there being sufficient charge in each of the energy storage devices to perform the expected future workload and/or power usage of the computing device 102. If one or more of the energy storage devices do not have sufficient charge to perform the expected future workload and/or power usage of the computing device 102 then various other actions can be taken, such as providing more power from the energy storage device having a lower charge than the other energy storage device, providing power to the energy storage devices based on the predicted availability of the energy storage devices, and so forth.

The prediction module 214 can estimate or predict the expected future workload and/or power usage of the computing device 102 in a variety of different manners. The prediction module 214 estimates or predicts the expected future workload and/or power usage of the computing device 102 as an aggregate function of location, user activity, and derived intent. In one or more embodiments, the prediction module 214 maintains a record (e.g., over a matter of weeks or months) indicating times of the day and/or days of the week and the power usage during those times and/or days. From this record, the prediction module 214 can identify usage patterns that indicate power usage of the computing device 102. Any of a variety of public and/or proprietary techniques can be used to analyze the record to identify usage patterns based on time and/or day. Additionally or alternatively, the prediction module 214 maintains a record of applications run on the computing device 102 and the power usage while those applications are run. From this record, the prediction module 214 can identify usage patterns that indicate power usage of the computing device 102 based on application(s) running. Any of a variety of public and/or proprietary techniques can be used to analyze the record to identify usage patterns.

For example, if every Monday (or at least a threshold number of Mondays, such as 80%) from 7:00 am to 10:00 am a particular amount of power (e.g., 1500 milliamp hours (mAh)) is used, then the prediction module 214 can predict that on the following Monday from 7:00 am to 10:00 am the computing device will use that same particular amount of power (e.g., 1500 mAh). By way of another example, if every day of the week (or at least a threshold number of days, such as 75%) from noon to 1:00 pm the computing device uses a particular amount of power (e.g., 30 mAh), then the prediction module 214 can predict that, if it is currently 11:00 am, the computing device will use 30 mAh from noon to 1:00 pm today. By way of yet another example, if every time (or at least a threshold number of times, such as 70%) an image processing application is run on the computing device the computing device uses 1000 milliamps per hour (mA/h), then the prediction module 214 can predict that, if that image processing is currently running on the computing device then the computing device will currently use 1000 mA/h.

Additionally or alternatively, the prediction module 214 can estimate or predict the expected future workload and/or power usage of the computing device 102 based on any of a variety of other data. The prediction module 214 can obtain data from various different sources and analyze the data using any of a variety of public and/or proprietary techniques to identify expected future usage patterns.

By way of example, the prediction module 214 can obtain data from a calendar of the user of the computing device 102. The past usage data (the record indicating times of the day and/or days of the week and the power usage during those times and/or days) can be compared to the user's calendar and a determination made that during meetings (or meetings at particular locations) the computing device uses a particular amount of power (e.g., 50 mA/h). The prediction module 214 can predict, for example, that the computing device will also use 50 mA/h during upcoming meetings (or meetings at particular locations) identified in the user's calendar, or more than 50 mA/h (e.g., 70 mA/h) if the user is marked as meeting presenter.

By way of example, the prediction module 214 can obtain data from a calendar and/or digital personal assistant (e.g., the Cortana® personal assistant) of the user of the computing device 102. The prediction module 214 can predict, given this obtained data, when the user will be away from the computing device 102 (e.g., for a meeting, for coffee, etc.). The prediction module 214 can further predict, for example, that the computing device will use a small amount of power (e.g., 5 mA/h) while the user is away from the computing device 102.

By way of example, the prediction module 214 can obtain location data for the computing device 102, such as from a location awareness module of the computing device 102. The past usage data (the record indicating times of the day and/or days of the week and the power usage during those times and/or days) can be compared to the user's locations and a determination made that at certain locations (e.g., home) the computing device uses a particular amount of power (e.g., 100 mA/h). The prediction module 214 can predict, for example, that the computing device will also use 100 mA/h when the user is next at home.

By way of example, the prediction module 214 can obtain data from a cloud service that collects usage data for computing devices. The cloud service can provide an indication of times of the day and/or days of the week and the power usage during those times and/or days for other computing devices of the same type as computing device 102. The prediction module 214 can predict, for example, that the computing device will use similar or the same amount of power during those times of the day and/or days of the week indicated by the cloud service.

Given the information from static criteria determination module 210, the dynamic system criteria determination module 212, and/or the prediction module 214, the energy storage device selection module 216 can readily select which energy storage devices 202 to charge at any particular time. The determination of which energy storage device(s) 202 to charge can be made at various times, such as at regular or irregular intervals (e.g., some time duration), in response to certain events (e.g., a temperature in thermal zone satisfying a threshold value, such as 80% of a maximum temperature desired by a designer or supplier of the computing device 102), and so forth.

In one or more embodiments, the energy storage device selection module 216 uses the individual criteria as discussed above. The energy storage device selection module 216 can use individual criteria or alternatively any combination of criteria. Additionally or alternatively, the energy storage device selection module 216 can apply various different rules or algorithms to determine which energy storage device(s) 202 to charge at any given time.

In one or more embodiments, the energy storage device selection module 216 attempts to satisfy all the criteria used by the energy storage device charge selection system 126. Although various criteria are discussed herein, it should be noted that not all of the criteria discussed herein need by used by the energy storage device charge selection system 126. Additionally or alternatively, additional criteria can also be used by the energy storage device charge selection system 126.

If all of the criteria used by the energy storage device charge selection system 126 can be satisfied, then the energy storage device selection module 216 selects which energy storage device(s) to charge at any given time so that all the criteria used by the energy storage device charge selection system 126 are satisfied. However, situations can arise where all of the criteria cannot be satisfied. For example, a removable energy storage device 202 may be predicted to be no longer present in the near future but is the only energy storage device that is not in a thermally hot zone, so one criteria may indicate to charge that energy storage device but another criteria indicates not to charge that energy storage device.

In one or more embodiments, each criteria is assigned a different classification. Various different classification levels with various different labels can be used, and these classification levels can be assigned statically and/or dynamically. Any of a variety of different classification names or labels can be used. One example of classification levels is (in order of priority or importance) critical, important, and informational. Other classification levels or labels can alternatively be used, such as a number or an “importance” value (e.g., 0 through 100). Higher classification levels are given priority over lower classification levels. For example, assume that a removable energy storage device being predicted to be no longer present in the near future is given a classification level of important, and the energy storage device being in a thermally stable zone is given a classification level of critical (which is higher than important). If the removable energy storage device 202 that is predicted to be no longer present in the near future is the only energy storage device in a thermally stable zone, then the energy storage device selection module 216 selects to charge that energy storage device 202 rather than other energy storage devices because selecting an energy storage device in a thermally stable zone is given priority over selecting the energy storage device that is predicted to not be present in the near future. However, it should be noted that this selection may be overturned. For example, the energy storage device charge selection system 126 may choose to continue with rapid charging even though the computing device 102 is running hot and indicate to the operating system 108 that the operating system 108 should throttle the software and/or hardware performance levels. This decision is made dynamically based on current computing device state, user intent, and predicted energy requirements of the computing device and state of charge. This dynamic nature of the of the energy storage device charge selection system 126 provides better energy storage device charging management than is provided by static policies alone.

In one or more embodiments, situations can also arise in which criteria at the same classification level conflict with one another. Such situations can be resolved in various manners, such as by using priority levels assigned to the different criteria. These priority levels can be assigned statically and/or dynamically. Any of a variety of different priority names or labels can be used. One example of labels is (in order of priority or importance) high, medium, and low. If two different criteria having the same classification level conflict (e.g., one criteria indicates that a particular energy storage device should be used and another indicates that particular energy storage device should not be used), then the energy storage device selection module 216 applies the criteria having the higher priority. However, if two different criteria having the same priority level but different classification levels conflict, then the energy storage device selection module 216 applies the criteria having the higher classification level.

The evaluation of classifications levels and priority levels can alternatively be performed in the reverse order. For example, if two different criteria conflict (e.g., one criteria indicates that a particular energy storage device should be charged and another indicates that particular energy storage device should not be charged), then the energy storage device selection module 216 applies the criteria having the higher priority. Situations can arise in which criteria at the same priority level conflict with one another. Such situations can be resolved in various manners, such as by using classification levels assigned to the different criteria. E.g., if two different criteria having the same priority level conflict (e.g., one criteria indicates that a particular energy storage device should be charged and another indicates that particular energy storage device should not be charged), then the energy storage device selection module 216 applies the criteria having the higher classification level.

In one or more embodiments, the energy storage device selection module 216 applies battery age balancing in selecting energy storage devices. The battery age balancing can be considered an additional criteria. Battery age balancing refers to the act of charging two or more energy storage devices such that they are charged proportionally according to their size, chemistry, and designed cycle count. In other words, the act of age balancing intends to charge the least degraded batteries as much as possible. Many energy storage devices degrade (e.g., lose capacity) as the number of charge/discharge cycles they've undergone increases. By performing battery age balancing, energy storage device degradation is reduced in the computing device 102 (e.g., the energy storage devices degrade at approximately the same rate).

The energy storage device selection module 216 can prepare the computing device for effective battery age balancing in various different situations. For example, in situations in which removable (e.g., hot-swappable) energy storage devices in the computing device (e.g., one or more removable energy storage devices in the computing device or one or more hot-swappable removable energy storage devices) are predicted to be present in the near future and aggregate energy present in all energy storage devices 202 is sufficient to power the computing device, then the energy storage device selection module 216 selects the energy storage devices 202 that are degraded the least. Additionally, in circumstances where non-swappable or cold-swappable energy storage devices have aged un-uniformly, the energy storage device selection module 216 will aid battery age balancing for these devices as well. This age balancing assistance can be performed, for example, whenever the energy storage device selection module 126 identifies that the charge available in the energy storage devices is sufficient to power the computing device 102 (e.g., up-time of the computing device will not be compromised due to lack of available charge in the energy storage devices).

It should also be noted that although discussions are made herein to selecting which energy storage device to charge, the selection can additionally or alternatively be a selection of what ratio to provide power to multiple different energy storage devices. For example, using the criteria discussed herein the energy storage device selection module 216 can select two energy storage devices (e.g., two energy storage devices in the same thermal zone) and provide power to both (e.g., 50% of the available charging power to both, more power (e.g., 75% of the available charging power) to one energy storage device and the remaining power (e.g., 25% of the available charging power) to the other energy storage device), and so forth.

The techniques discussed herein provide a dynamic approach to selecting which of multiple energy storage devices to charge. This dynamic approach various based on multiple different criteria, and can factor in the way in which a user uses his or her computing device. Thus, rather than having a one-size-fits-all approach to selecting an energy storage device to charge, the dynamic approach discussed herein is customized or tailored to the individual user. This results in reducing the energy loss in energy storage devices during operation of the computing device, approximately uniform aging of energy storage devices, improved thermal stability of the computing device, and extended usability of the computing device.

Example Charging Architecture

Generally speaking, an energy storage device system 128 having multiple energy storage devices may be configured in various ways and employ a variety of different types of energy storage devices. In one or more implementations, different energy storage devices 202 included with a system have different characteristics, such as differences in one or more of battery chemistry, capacity, voltage, size, shapes and/or state of charge (SOC), to name a few examples. Using different types of energy storage devices provides flexibility for design of the energy storage device system and circuit boards, and consequently enables device developers to make better utilization of internal space to provide devices having increased battery life and efficiency. The different energy storage devices are arranged in a circuit that enables selective switching among the energy storage devices.

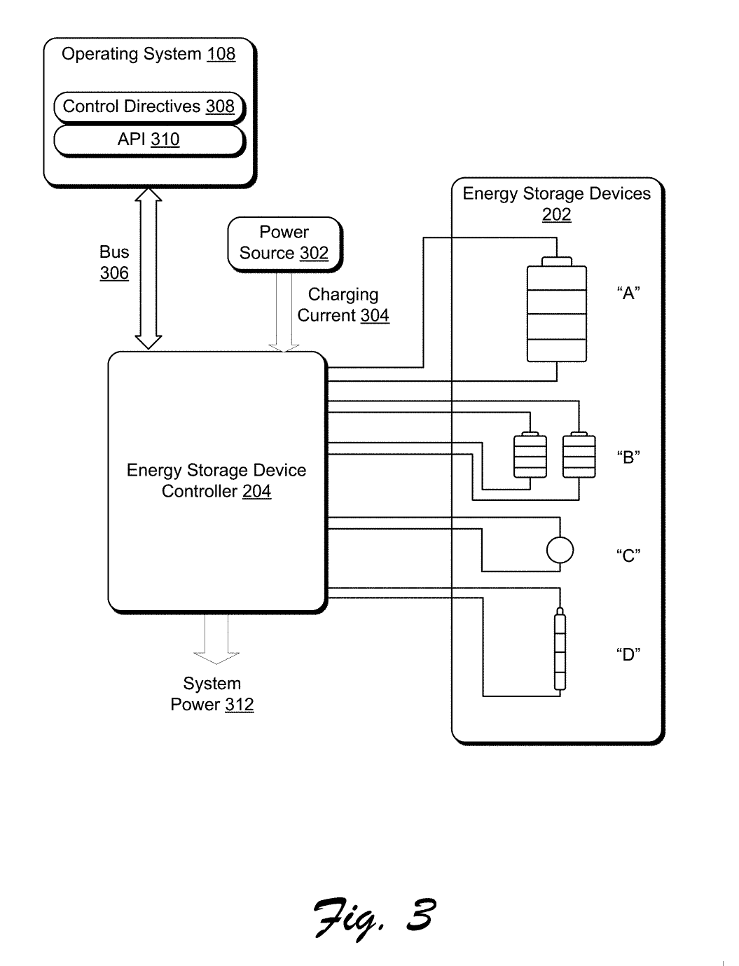

In particular, FIG. 3 depicts generally at 300 an illustrative example charging architecture for an energy storage device system having multiple energy storage devices 202. The energy storage devices 202 may be connected in a circuit that includes an energy storage device controller 204 as described in relation to the example of FIG. 2. In the depicted example, energy storage devices 202 include different representative energy storage devices labeled “A”,“B”, “C”, and “D”. Each of the energy storage devices is connected directly to the charge energy storage device 204 in a manner that provides individual current paths to and from each of the energy storage devices for charging and/or discharge. The depicted energy storage devices 202 are also represented as a collection of heterogeneous energy storage devices, although the energy storage devices 202 can alternatively be the same types of energy storage devices.

The energy storage device controller 204 is depicted as being connected to a power source 302 from which charging current 304 may be obtained to charge the energy storage devices 202. To perform the charging, the energy storage device controller 204 may implement a charging strategy that selects different energy storage devices for charging at different times at determined by the energy storage device selection module 216 as previously discussed. When power is supplied via the power source 302, switching hardware 206 of the energy storage device controller 204 can direct the current to energy storage devices using the individual current paths (e.g., on a per-energy storage device basis).

As further represented in FIG. 3, the energy storage device controller 204 may be configured to coordinate charging activity with an operating system 108 via communications exchanged via a bus 306 (e.g., an I²C bus or other suitable communication bus) or other suitable communication channel. In particular, the operating system 108 may include an energy storage device selection module 216 or comparable functionally that is operable to direct operation of the energy storage device controller 204 as discussed herein. In order to do so, the operating system 108 may communicate control directives 308 to the energy storage device controller 204 that provides indications regarding which energy storage devices 202 to charge at which times. The control directives 308 are configured to dynamically program the energy storage device controller 204 to charge the desired energy storage devices 202 at the desired times as indicated by the energy storage device selection module 216.

Control directives 308 may be configured as any suitable messages, signals, or communications that are effective to convey information regarding policy decisions and selected strategies to set-up the energy storage device controller 204 accordingly. By way of an example and not limitation, the operating system may expose an application programming interface (API) 310 that may be used by the energy storage device selection module 216 and/or other applications to interact with and configured the charge controller 204. In one approach, the API 310 may be invoked to communicate control directives 308 that are configured to set registers of the energy storage device controller 204. In any event, the control directives 308 provide a mechanism to access and manipulate charging functionality provided via the energy storage device controller 204 to implement different strategies and tailor charging to different scenarios.

It should be noted that although various different values, labels, levels, and so forth are discussed herein, these are examples and the techniques discussed herein are not limited to these examples. For example, any specific threshold values and/or labels discussed herein are only examples, and various other threshold values and/or labels can additionally or alternatively be used. These examples are illustrations only and are not intended to limit the scope of the techniques discussed herein.

Example Procedures

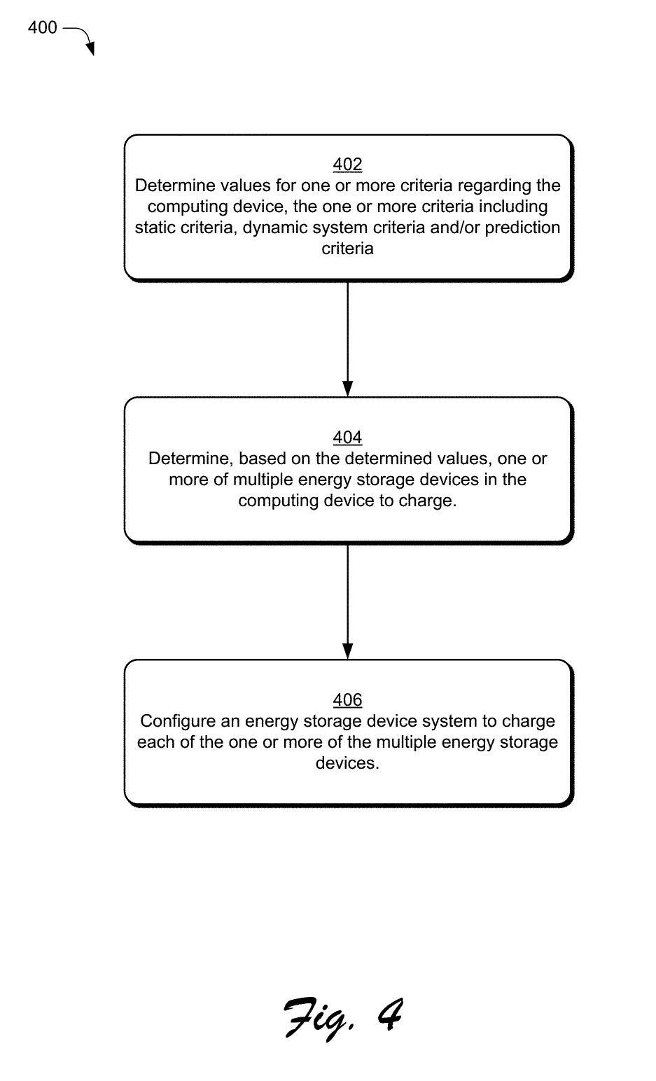

Further aspects of the dynamic energy storage device charging techniques are discussed in relation to example procedure of FIG. 4. The procedures described in this document may be implemented utilizing the environment, system, devices, and components described herein and in connection with any suitable hardware, software, firmware, or combination thereof. The procedures may be represented as a set of blocks that specify operations performed by one or more entities and are not necessarily limited to the orders shown for performing the operations by the respective blocks.

FIG. 4 is a flow diagram that describes details of an example procedure 400 for dynamic energy storage device charging in accordance with one or more implementations. The procedure 400 describes details of charging multiple energy storage devices. The procedure 400 can be implemented by way of a suitably configured computing device, such as by way of an operating system 108, energy storage device charge selection system 126, and/or other functionality described in relation to the examples of FIGS. 1-3.

Values for one or more criteria regarding the computing device are determined (block 402). The one or more criteria can be static criteria, dynamic system criteria, and/or prediction criteria. By way of example, the values can be the temperatures of each of multiple thermal zones in a computing device, whether a removable energy storage device is predicted to be no longer present (e.g., removed) in the near future, and so forth.

One or more of multiple energy storage devices in the computing device to charge are determined based on the determined values (block 404). Power can be provided to a single energy storage device, or alternatively to multiple energy storage devices.

An energy storage device system is configured to charge each of the one or more energy storage devices (block 406). Power is provided to the one or more energy storage devices to charge the one or more energy storage devices.

Example System

FIG. 5 illustrates an example system 500 that includes an example computing device 502 that is representative of one or more computing systems and/or devices that may implement the various techniques described herein. The computing device 502 may be, for example, a server of a service provider, a device associated with a client (e.g., a client device), an on-chip system, and/or any other suitable computing device or computing system.

The example computing device 502 as illustrated includes a processing system 504, one or more computer-readable media 506, and one or more I/O interfaces 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 506 is illustrated as including memory/storage 512. The memory/storage 512 represents memory/storage capacity associated with one or more computer-readable media. The memory/storage 512 may include volatile media (such as random access memory (RAM)) and/or nonvolatile media (such as read only memory (ROM), Flash memory, optical disks, magnetic disks, and so forth). The memory/storage 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

Input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone for voice operations, a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 502 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “communication media.”

“Computer-readable storage media” refers to media and/or devices that enable storage of information in contrast to mere signal transmission, carrier waves, or signals per se. Computer-readable storage media does not include signal bearing media, transitory signals, or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Communication media” may refer to signal-bearing media that is configured to transmit instructions to the hardware of the computing device 502, such as via a network. Communication media typically may embody computer readable instructions, data structures, program modules, or other data in a modulated data signal, such as carrier waves, data signals, or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 510 and computer-readable media 506 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules including the operating system 108, applications 110, energy storage device charge selection system 126, and other program modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of modules as a module that is executable by the computing device 502 as software may be achieved at least partially in hardware, e.g., through use of computer-readable storage media and/or hardware elements 510 of the processing system. The instructions and/or functions may be executable/operable by one or more articles of manufacture (for example, one or more computing devices 502 and/or processing systems 504) to implement techniques, modules, and examples described herein.

As further illustrated in FIG. 5, the example system 500 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 500, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 502 may assume a variety of different configurations, such as for computer 514, mobile 516, and television 518 uses. Each of these configurations includes devices that may have generally different constructs and capabilities, and thus the computing device 502 may be configured according to one or more of the different device classes. For instance, the computing device 502 may be implemented as the computer 514 class of a device that includes a personal computer, desktop computer, a multi-screen computer, laptop computer, netbook, and so on.

The computing device 502 may also be implemented as the mobile 516 class of device that includes mobile devices, such as a mobile phone, portable music player, portable gaming device, a tablet computer, a multi-screen computer, and so on. The computing device 502 may also be implemented as the television 518 class of device that includes devices having or connected to generally larger screens in casual viewing environments. These devices include televisions, set-top boxes, gaming consoles, and so on.

The techniques described herein may be supported by these various configurations of the computing device 502 and are not limited to the specific examples of the techniques described herein. This is illustrated through inclusion of the energy storage device charge selection system 126 and the energy storage device system 128 on the computing device 502. The functionality represented by energy storage device charge selection system 126 and other modules/applications may also be implemented all or in part through use of a distributed system, such as over a “cloud” 520 via a platform 522 as described below.

The cloud 520 includes and/or is representative of a platform 522 for resources 524. The platform 522 abstracts underlying functionality of hardware (e.g., servers) and software resources of the cloud 520. The resources 524 may include applications and/or data that can be utilized while computer processing is executed on servers that are remote from the computing device 502. Resources 524 can also include services provided over the Internet and/or through a subscriber network, such as a cellular or Wi-Fi network.

The platform 522 may abstract resources and functions to connect the computing device 502 with other computing devices. The platform 522 may also serve to abstract scaling of resources to provide a corresponding level of scale to encountered demand for the resources 524 that are implemented via the platform 522. Accordingly, in an interconnected device embodiment, implementation of functionality described herein may be distributed throughout the system 500. For example, the functionality may be implemented in part on the computing device 502 as well as via the platform 522 that abstracts the functionality of the cloud 520.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A method implemented in a computing device having an energy storage device system including multiple energy storage devices, the method comprising: determining, for each of multiple thermal zones of the computing device, a temperature of the thermal zone; determining, based on multiple criteria regarding operation of the computing device, one or more of the multiple energy storage devices to charge, the multiple criteria including the temperature of each of the one or more thermal zones; and configuring the energy storage device system to charge each of the one or more of the multiple energy storage devices.

Alternatively or in addition to any of the above described methods, any one or combination of: wherein the determining one or more of the multiple energy storage devices to charge comprises determining to charge one of the multiple energy storage devices that is not in a thermally hot zone; wherein each of the multiple energy storage devices is in a thermally hot zone, wherein the determining one or more of the multiple energy storage devices to charge comprises determining to charge each of a subset of the multiple energy storage devices, and wherein the configuring comprises configuring the energy storage device system to duty cycle charging of the subset multiple energy storage devices; wherein the multiple criteria includes for each of the multiple energy storage devices an indication of a thermal zone in which the energy storage device is located, and the determining one or more of the multiple energy storage devices to charge comprises duty cycling ones of the multiple energy storage devices in different thermal zones; wherein the multiple criteria include removable energy storage device presence predictions, and the determining one or more of the multiple energy storage devices to charge comprises determining to charge a first energy storage device of the multiple energy storage devices in response to predicting that a second energy storage device of the multiple energy storage devices will not be used for powering the computing device; wherein the multiple criteria include AC power source connection duration predictions, and the determining one or more of the multiple energy storage devices to charge comprises determining to charge one of the multiple energy storage devices capable of rapid charging in response to predicting that the computing device will be connected to an AC power source for less than a threshold amount of time; wherein each of the energy storage devices comprises a battery; wherein the determining one or more of the multiple energy storage devices to charge comprises determining the one or more of the multiple energy storage devices using battery age balancing; wherein the determining the one or more of the multiple energy storage devices using battery age balancing comprises determining to use battery age balancing in response to predicting that one or more removable energy storage devices are predicted to be present in the computing device or energy available in one or more energy storage devices are predicted to be sufficient to conduct age balancing without compromising computing device up-time.

A method implemented in a computing device having an energy storage device system including multiple energy storage devices, the method comprising: determining values for multiple criteria regarding the computing device and/or multiple energy storage devices, wherein the multiple criteria include removable energy storage device presence predictions; determining, based on the values for the multiple criteria, a first energy storage device of the multiple energy storage devices to charge, the values for the multiple criteria including an indication that a second energy storage device of the multiple energy storage devices is predicted to be removed from the computing device within a threshold amount of time; and configuring the energy storage device system to charge the first energy storage device.

Alternatively or in addition to any of the above described methods, any one or combination of: wherein the multiple criteria include AC power source connection duration predictions, and the determining one or more of the multiple energy storage devices to charge comprises determining to charge one of the multiple energy storage devices capable of rapid charging in response to predicting that the computing device will be connected to an AC power source for less than a threshold amount of time; wherein the multiple criteria include expected future workload and/or power usage predictions, and the determining one or more of the multiple energy storage devices to charge comprises determining to charge the multiple energy storage devices in a balanced manner in response to predicting that there is sufficient charge in the energy storage devices to perform the expected future workload and/or power usage of the computing device; wherein the determining one or more of the multiple energy storage devices to charge comprises determining the one or more of the multiple energy storage devices using battery age balancing.

A computing device comprising: an energy storage device system including multiple energy storage devices; and an energy storage device charge selection system configured to communicate, to the energy storage device system, an indication of which of the multiple energy storage devices to charge, the energy storage device charge selection system including: a dynamic system criteria determination module configured to determine values for characteristics of the energy storage devices and/or the computing device that change while the computing device operates, including temperatures of one or more thermal zones in the computing device; and an energy storage device selection module configured to select, based on the values determined by the hardware criteria determination module and the dynamic system criteria determination module, which of the multiple energy storage devices to charge.

Alternatively or in addition to any of the above described computing devices, any one or combination of: wherein the energy storage device charge selection system further includes a prediction module configured to determine values for characteristics of estimated or predicted usage of the computing device, and the energy storage device selection module being further configured to select, based at least in part on the values determined by the prediction module, a first energy storage device of the multiple energy storage devices to charge in response to predicting that a second energy storage device of the multiple energy storage devices will not be used for powering the computing device; wherein the prediction module is further configured to determine values for AC power source connection duration predictions, and the energy storage device selection module is further configured to determine to charge one of the multiple energy storage devices capable of rapid charging in response to predicting that the computing device will be connected to an AC power source for less than a sufficient amount of time to ingest enough energy to power the system at lower charge rate; wherein the prediction module is further configured to determine expected future workload and/or power usage predictions, and the energy storage device selection module is further configured to charge the multiple energy storage devices in a balanced manner in response to predicting that there is sufficient charge in the energy storage devices to perform the expected future workload and/or power usage of the computing device; wherein the prediction module is further configured to predict a small charging window and the energy storage device selection module is further configured to employ thermal conditioning techniques to consume full charging current; wherein the energy storage device selection module is further configured to provide an indication to an operating system of the computing device to throttle software and/or hardware performance levels in the computing device to allow rapid charging of one or more of the multiple energy storage devices; wherein the prediction module is further configured to predict an upcoming charging window, a duration of the upcoming charging window, and an amount of power predicted to be available during the charging window.

### CONCLUSION

Although the example implementations have been described in language specific to structural features and/or methodological acts, it is to be understood that the implementations defined in the appended claims are not necessarily limited to the specific features or acts described. Rather, the specific features and acts are disclosed as example forms of implementing the claimed features.

What is claimed is:

1. A method implemented in a computing device having an energy storage device system including multiple energy storage devices, the method comprising:
determining, for each of multiple thermal zones of the computing device, a temperature of the thermal zone;
determining, based on multiple criteria regarding operation of the computing device, one or more of the multiple energy storage devices to charge, the multiple criteria including the temperature of each of the one or more thermal zones; and
configuring the energy storage device system to charge each of the one or more of the multiple energy storage devices.

2. The method as recited in claim 1, wherein the determining one or more of the multiple energy storage devices to charge comprises determining to charge one of the multiple energy storage devices that is not in a thermally hot zone.

3. The method as recited in claim 1, wherein each of the multiple energy storage devices is in a thermally hot zone, wherein the determining one or more of the multiple energy storage devices to charge comprises determining to charge each of a subset of the multiple energy storage devices, and wherein the configuring comprises configuring the energy storage device system to duty cycle charging of the subset multiple energy storage devices.

4. The method as recited in claim 1, wherein the multiple criteria includes for each of the multiple energy storage devices an indication of a thermal zone in which the energy storage device is located, and the determining one or more of the multiple energy storage devices to charge comprises duty cycling ones of the multiple energy storage devices in different thermal zones.

5. The method as recited in claim 1, wherein the multiple criteria include removable energy storage device presence predictions, and the determining one or more of the multiple energy storage devices to charge comprises determining to charge a first energy storage device of the multiple energy storage devices in response to predicting that a second energy storage device of the multiple energy storage devices will not be used for powering the computing device.

6. The method as recited in claim 1, wherein the multiple criteria include AC power source connection duration predictions, and the determining one or more of the multiple energy storage devices to charge comprises determining to charge one of the multiple energy storage devices capable of rapid charging in response to predicting that the computing device will be connected to an AC power source for less than a threshold amount of time.

7. The method as recited in claim 1, wherein each of the energy storage devices comprises a battery.

8. The method as recited in claim 1, wherein the determining one or more of the multiple energy storage devices to charge comprises determining the one or more of the multiple energy storage devices using battery age balancing.

9. The method as recited in claim 8, wherein the determining the one or more of the multiple energy storage devices using battery age balancing comprises determining to use battery age balancing in response to predicting that one or more removable energy storage devices are predicted to be present in the computing device or energy available in one or more energy storage devices are predicted to be sufficient to conduct age balancing without compromising computing device up-time.

10. A method implemented in a computing device having an energy storage device system including multiple energy storage devices, the method comprising:
determining values for multiple criteria regarding the computing device and/or multiple energy storage devices, wherein the multiple criteria include removable energy storage device presence predictions;
determining, based on the values for the multiple criteria, a first energy storage device of the multiple energy storage devices to charge, the values for the multiple criteria including an indication that a second energy storage device of the multiple energy storage devices is predicted to be removed from the computing device within a threshold amount of time; and
configuring the energy storage device system to charge the first energy storage device.

11. The method as recited in claim 10, wherein the multiple criteria include AC power source connection duration predictions, and the determining one or more of the multiple energy storage devices to charge comprises determining to charge one of the multiple energy storage devices capable of rapid charging in response to predicting that the computing device will be connected to an AC power source for less than a threshold amount of time.

12. The method as recited in claim 10, wherein the multiple criteria include expected future workload and/or power usage predictions, and the determining one or more of the multiple energy storage devices to charge comprises determining to charge the multiple energy storage devices in a balanced manner in response to predicting that there is sufficient charge in the energy storage devices to perform the expected future workload and/or power usage of the computing device.

13. The method as recited in claim 10, wherein the determining one or more of the multiple energy storage devices to charge comprises determining the one or more of the multiple energy storage devices using battery age balancing.

14. A computing device comprising:
an energy storage device system including multiple energy storage devices; and
an energy storage device charge selection system configured to communicate, to the energy storage device system, an indication of which of the multiple energy storage devices to charge, the energy storage device charge selection system including:
a dynamic system criteria determination module configured to determine values for characteristics of the energy storage devices and/or the computing device that change while the computing device operates, including temperatures of one or more thermal zones in the computing device; and
an energy storage device selection module configured to select, based on the values determined by the hardware criteria determination module and the dynamic system criteria determination module, which of the multiple energy storage devices to charge.

15. The computing device as recited in claim 14, wherein the energy storage device charge selection system further includes a prediction module configured to determine values for characteristics of estimated or predicted usage of the computing device, and the energy storage device selection module being further configured to select, based at least in part on the values determined by the prediction module, a first energy storage device of the multiple energy storage devices to charge in response to predicting that a second energy storage device of the multiple energy storage devices will not be used for powering the computing device.

16. The computing device as recited in claim 15, wherein the prediction module is further configured to determine values for AC power source connection duration predictions, and the energy storage device selection module is further configured to determine to charge one of the multiple energy storage devices capable of rapid charging in response to predicting that the computing device will be connected to an AC power source for less than a sufficient amount of time to ingest enough energy to power the system at lower charge rate.

17. The computing device as recited in claim 14, wherein the prediction module is further configured to determine expected future workload and/or power usage predictions, and the energy storage device selection module is further configured to charge the multiple energy storage devices in a balanced manner in response to predicting that there is sufficient charge in the energy storage devices to perform the expected future workload and/or power usage of the computing device.

18. The computing device as recited in claim 14, wherein the prediction module is further configured to predict a small charging window and the energy storage device selection module is further configured to employ thermal conditioning techniques to consume full charging current.

19. The computing device as recited in claim 14, wherein the energy storage device selection module is further configured to provide an indication to an operating system of the computing device to throttle software and/or hardware performance levels in the computing device to allow rapid charging of one or more of the multiple energy storage devices.

20. The computing device as recited in claim 14, wherein the prediction module is further configured to predict an upcoming charging window, a duration of the upcoming charging window, and an amount of power predicted to be available during the charging window.
